(19) United States
(12) Patent Application Publication
(10) Pub. No.: US 2005/0258947 A1
(43) Pub. Date: Nov. 24, 2005

(54) Wireless light control system

(76) Inventor: Benjamin Kunianski, Troy, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/130,461

(22) Filed: May 16, 2005

Related U.S. Application Data
(60) Provisional application No. 60/572,711, filed on May 20, 2004.

(51) Int. Cl. G08B 21/00

(52) U.S. Cl. 340/431; 340/471

(57) ABSTRACT

A wireless light control system for use in conjunction with a towing vehicle having a plurality of lights and a trailer also having a plurality of corresponding lights. The control system includes a control circuit mounted to the vehicle which receives electrical inputs representative of the status of the towing vehicle lights and a radio transmitter which transmits a radio signal representative of the status of the towing vehicle lights. A responder circuit is mounted to the trailer and includes a radio receiver which receives the radio signal from the transmitter. The responder circuit also includes a circuit responsive to the received signal for generating output signals to selectively activate the lights in the trailer system so that the trailer lights are activated in synchronism with corresponding lights on the towing vehicle.

### RELATED APPLICATION

This application claims priority of U.S. Provisional Patent Application Ser. No. 60/572,711 filed May 20, 2004, which is incorporated herein by reference.

### BACKGROUND OF THE INVENTION

I. Field of the Invention

The present invention relates to a wireless light control system and, more particularly, to such a system used with a towing vehicle and trailer combination.

II. Description of Related Art

Motor vehicles are oftentimes used to tow tractors of one sort or another. For example, boats, cargo containers and the like are oftentimes towed by motor vehicles.

In order to tow a trailer, the trailer is typically mechanically secured to the motor vehicle by a hitch located at the rear of the vehicle. Additionally, many trailers by law include a lighting system which must be operational during towing of the trailer. This lighting system includes the taillights, brake lights, and left and right-hand turn signal lights. These lights on the trailer are typically connected to a wiring harness having a connecting terminal at the front of the vehicle and thus adjacent the rear of the motor vehicle which is used to tow the trailer.

In order to coordinate the activation of the lights in the trailer with the motor vehicle, the motor vehicle also includes a wiring harness having a plurality of output pins, each of which corresponds to one of the lights on the trailer lighting system. The wiring harness on the towing motor vehicle is then connected to the wiring harness on the trailer so that, upon activation of the various lights on the motor vehicle, the corresponding light on the trailer lighting system is also activated.

The previously known wiring harnesses used to electrically connect the lighting system of the towing vehicle with the lighting system of the towed trailer, however, have not proven wholly satisfactory in use. One disadvantage is that the connector for the wiring harness on the trailer and the towing vehicle are oftentimes difficult to access.

Additionally, the various pins or connectors in the wiring harnesses for both the towed trailer as well as the towing vehicle oftentimes become corroded, covered with debris or otherwise rendered ineffective so that, once the connectors on both the towing vehicle and trailer are secured together, an improper or insufficient electrical connection is formed between the trailer and the towing vehicle. When this happens, it is necessary to clean the connectors on the towing vehicle and/or the trailer in order to restore the proper electrical connection between the trailer and the towing vehicle lighting systems. Such cleaning of the connectors, however, is oftentimes difficult and time consuming to accomplish.

### SUMMARY OF THE PRESENT INVENTION

The present invention provides a wireless light control system which overcomes all of the above-mentioned disadvantages of the previously known devices.

In brief, the present invention provides a control circuit which is mounted to the towing vehicle. This control circuit includes an encoder which receives an input signal from the wiring harness of the towing vehicle. As such, the encoder produces an output signal representative of the status of a plurality of the exterior lights of the towing vehicle. Furthermore, as used in this patent, the term “status” as it is applied to the lights in the lighting system means whether or not the light is on or off. Furthermore, the exterior lights which are encoded by the encoder include the taillights, brake lights, turn signal lights and running lights.

The encoder then has its output connected to a transmitter which transmits a radio signal representative of the status of the lights in the towing vehicle. Any conventional radio transmitter may be used and, preferably, the radio transmitter transmits at a relatively high frequency.

A responder circuit is mounted to the vehicle. This responder circuit includes the receiver which receives the radio signal from the transmitter and provides an output signal to a decoder. The decoder, in turn, decodes the received radio signal to determine the status of the exterior lights of the towing vehicle as transmitted by the transmitter. After the status of the exterior lights of the towing vehicle has been determined, the decoder generates an output signal to switch drivers which selectively control the activation of the lights in the trailer lighting system so that the trailer lights are activated in synchronism with the corresponding lights on the towing vehicle.

For example, once the brake light is activated on the towing vehicle, the transmitter transmits a signal representative that the brake has been activated on the towing vehicle. The receiver decodes the received signal and generates an output signal through the decoder and relay driver to activate the brake lights on the trailer. Furthermore, the transmission of the signal by the transmitter to the receiver is continuously iteratively performed so that only a small and virtually imperceptible delay occurs between the activation of a light on the towing vehicle and the activation of the corresponding light on the towed trailer.

A power supply, such as a battery, is also carried by the trailer and used to power not only the responder circuit, but also the various lights in the trailer lighting system. Additionally, a charger circuit is electrically connected with this power supply to substantially continuously recharge the power supply to ensure continuous power for the trailer lighting system.

A number of different charge circuits may be utilized without deviation from either the spirit or scope of the present invention. For example, in one embodiment the charger system comprises a solar panel which continuously charges the power source, at least during the daytime. Alternatively, a wind-driven generator or a generator driven by the rotation of the ground-engaging wheels on the trailer may be utilized to recharge the power source.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a perspective view illustrating a preferred embodiment of the present invention;

FIG. 2 is a block diagrammatic view illustrating the preferred embodiment of the present invention;

FIG. 3 is a view illustrating one exemplary charging system for the present invention;

FIG. 4 is an elevational view illustrating a second exemplary charging system for the present invention;

FIG. 5 is a view similar to FIGS. 3 and 4 and illustrating still a further exemplary charging system of the present invention; and

FIG. 6 is a view similar to FIGS. 3-5 and illustrating still a further exemplary charging system for the power source.

### DETAILED DESCRIPTION OF PREFERRED EMBODIMENTS OF THE PRESENT INVENTION

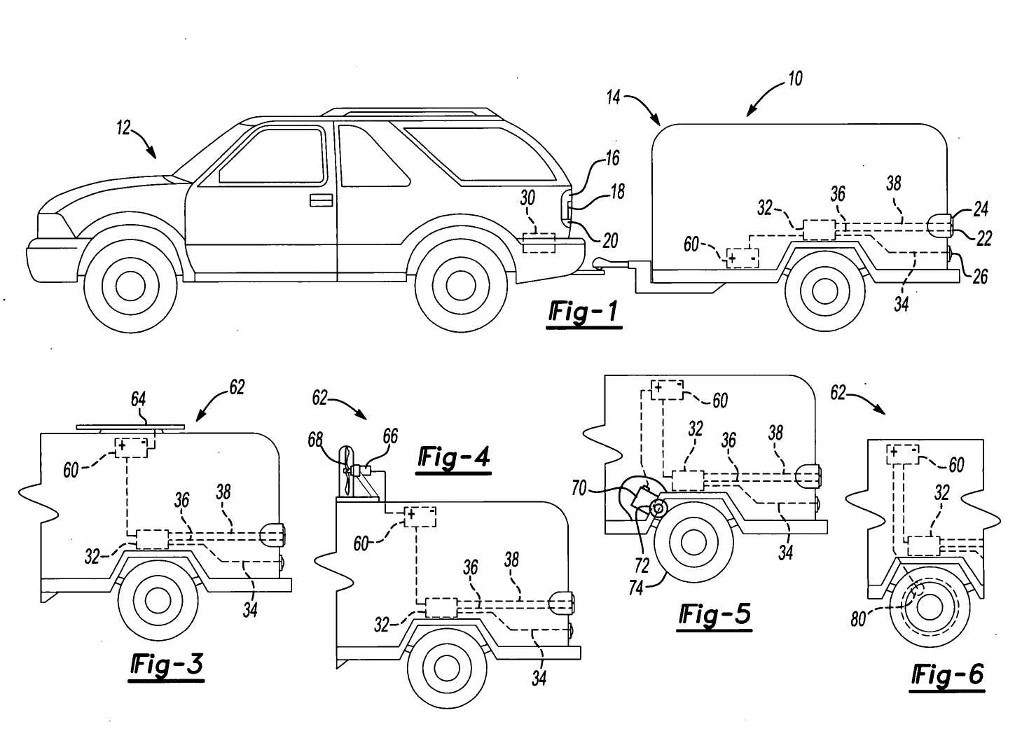

With reference first to FIG. 1, a preferred embodiment of the wireless light control system 10 is provided for use with a towing vehicle 12 and a trailer 14. In the well known fashion, the towing vehicle 12 includes a plurality of external lights, such as the taillight 16, brake lights 18 and turn signals 20. Similarly, the trailer 14 also includes a plurality of exterior lights such as a brake light 22, tail light 24 and turn signals 26. By law in many states, these lights 22-26 must be operated in synchronism with the corresponding lights 16-20 on the towing vehicle 12 whenever the trailer 14 is towed.

A control circuit 30 is mounted to the towing vehicle 12. The control circuit 30, the operation of which will be subsequently described, may be positioned in any convenient location in the towing vehicle 12. However, in practice, the control circuit 30 will preferably be mounted in the trunk or rear area of the towing vehicle 12.

Still referring to FIG. 1, a responder circuit 32 is mounted to the trailer 14. The control circuit 32 is electrically connected through lines 34, 36 and 38 to the lights 22-26 of the trailer 14 in order to selectively activate these lights 22-26 in the manner to be subsequently described.

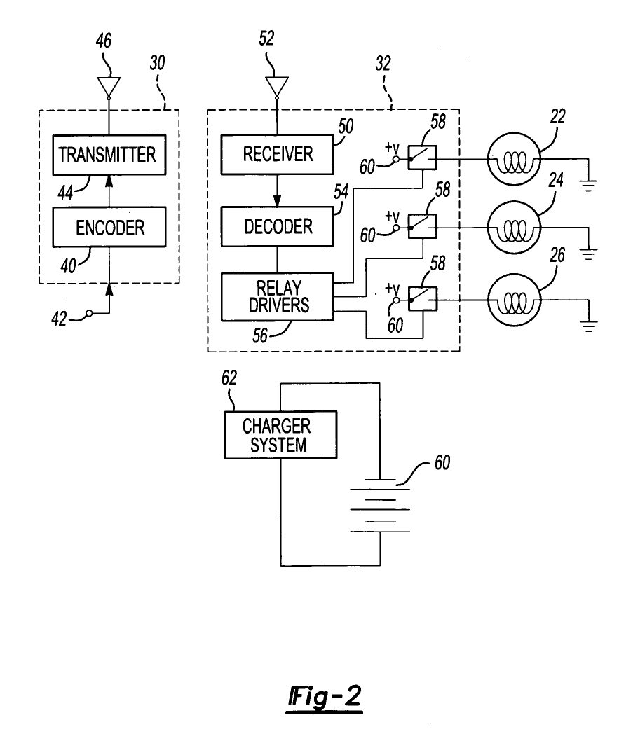

With reference now to FIG. 2, a block diagrammatic view of the wireless system 10 of the present invention is shown. A control circuit 30 includes an encoder 40 which receives an input signal from a wiring light harness 42 on the towing vehicle 12. Consequently, the encoder receives a signal representative of the status of the various lights in the exterior lighting system of the towing vehicle 12. The encoder 40 then provides an output signal to a radio transmitter 44 which transmits an output signal on its antenna 46 representative of the status of the exterior lights of the towing vehicle.

The responder circuit 32 includes a radio receiver 50 which receives the radio signal from the transmitter 44 on its antenna 52. Any conventional radio frequency may be used between the transmitter 44 and receiver 50 although, in practice, high frequency radio communication has proven effective.

Upon receipt of the radio signal, the receiver 50 provides an output signal to a decoder 54 which decodes the received radio signal from the transmitter 44 and determines the status of the exterior lights of the towing vehicle. The decoder 54 then provides the output signal of the decoded received signal to a plurality of switch drivers 56.

The relay driver 56 is electrically connected to a plurality of switches 58 wherein one switch 58 is electrically connected in series between an electrical power source 60 and each of the trailer lights 22-26. The switches 58 may be of any conventional construction and may comprise, for example, a solid state switch, mechanical relay, or the like. In any event, upon receipt of an output signal from the switch driver 56, the switches 58 are selectively activated and, upon doing so, the trailer lights 22-26 are selectively electrically connected to the power source 60 thus illuminating the lights 22-26.

In practice, the radio transmitter 44 continuously iteratively transmits the status of the various external lights of the towing vehicle. These transmitted signals are, in turn, continuously iteratively received by the receiver 50, decoded by the decoder 54, and the switches 58 selectively activated by the switch drivers 56 as a function of the received radio signal. Consequently, upon activation or deactivation of any particular exterior light on the towing vehicle, e.g. the brake light, the corresponding light on the trailer, e.g. the brake light, is substantially simultaneously and synchronously activated or deactivated, as the case may be. Consequently, all of the external lights 22-26 on the trailer are activated in accordance with the corresponding lights 16-20 on the towing vehicle 12.

Still referring to FIG. 2, a charger system 62 is electrically connected with the power source 60 which may comprise, for example, a battery. This charging system 62 thus continuously charges the battery 60 so that electrical power is continuously available to power not only the responder circuit 32 but also the exterior lights 22-26 on the trailer 14.

With reference now to FIG. 3, one exemplary charging system 62 is there illustrated as a solar panel 64 which receives solar energy and utilizes that solar energy to charge the battery 60. Such a charging system, however, would only effectively charge the battery 60 during daytime use.

With reference now to FIG. 4, an alternative charging system 62 is shown in which the charging system 62 includes a generator 66 which is rotatably driven by a wind-driven propeller 68. Thus, as the towing vehicle 12 tows the trailer 14, the propeller 68 rotatably drives the generator 66 and charges the electrical power source 60.

With reference now to FIG. 5, a still other alternate charging system 62 is shown in which a generator 70 includes a rotary drive wheel 72. This rotary drive wheel 72 is placed into frictional contact with a vehicle ground-engaging wheel 74. Consequently, as the vehicle wheel 74 rotates as the trailer 14 is being towed, the generator wheel 72 is rotatably driven which, in turn, drives the generator 70 and produces the electrical power to recharge the power source 60.

A variation of the electrical power charging system of FIG. 5 is illustrated in FIG. 6. In FIG. 6, an electrical generator 80 is mounted within the brake drum of the towing vehicle 14. Thus, as the brake drum rotates during movement of the trailer, the generator 80 is electrically connected to and recharges the electrical power source 60.

From the foregoing, it can be seen that the present invention provides a simple and yet effective wireless light control system between a towing vehicle and a trailer. Having described my invention, however, many modifications thereto will become apparent to those skilled in the art to which it pertains without deviation from the spirit of the invention as defined by the scope of the appended claims.

1. For use in conjunction with a towing vehicle having a plurality of lights and a trailer having a plurality of lights, a wireless light control system comprising:
a control circuit mounted to the vehicle, said control circuit receiving electrical inputs representative of the status of the towing vehicle lights and a radio transmitter which generates a radio signal representative of the status of the towing vehicle lights,
a responder circuit mounted to the trailer, said responder circuit having a radio receiver which receives the radio signal from said transmitter and circuit means responsive to said received signal for generating output signals to selectively activate the lights in the trailer lighting system so that the trailer lights are activated in synchronism with corresponding lights on the towing vehicle.

2. The invention as defined in claim 1 wherein said circuit means comprises a power source and a plurality of electrical switches, one switch being connected in series between said power source and each trailer light.

3. The invention as defined in claim 1 and comprising means carried by said trailer for recharging said power source.

4. The invention as defined in claim 3 wherein said recharging means comprises a solar panel.

5. The invention as defined in claim 3 wherein the trailer includes at least one ground-engaging wheel and wherein said recharging means comprises a generator mounted to the trailer, said generator having a driven member driven by rotation of the trailer wheel.

6. The invention as defined in claim 5 wherein said generator is mounted within a brake drum of the trailer wheel.

7. The invention as defined in claim 3 wherein said recharging means comprises a wind-powered generator.
